(19) United States
(12) Patent Application Publication
(10) Pub. No.: US 2018/0042277 A1
(43) Pub. Date: Feb. 15, 2018

(54) Soybean Processing Method

(71) Applicants: Geirmund VIK, Algard (NO); NAVITA PREMIUM FEED INGREDIENTS, INC., West Des Moines, IA (US)

(72) Inventor: Geirmund Vik, Algard (NO)

(21) Appl. No.: 15/546,906

(22) PCT Filed: Jan. 29, 2016
(86) PCT No.: PCT/US2016/015578

§ 371 Date: Jul. 27, 2017

(30) Foreign Application Priority Data
Jan. 29, 2015 (NO) 20150134

(51) Int. Cl. A23L 11/00; A23L 11/30

(52) U.S. Cl. CPC A23L 11/03; A23L 11/31

(57) ABSTRACT

A new method describing the preparation of protein concentrates from oilseeds particularly soybeans and soybean meal is disclosed. The method differs from current methods in that the method uses a combination of novel retention times and temperatures. Further, the method can be employed to refrain from the use of solvents such as hexane and ethanol.

### CROSS-REFERENCE TO RELATED APPLICATIONS

The present application claims the benefit of priority to International Application No. PCT/US2016/015578 filed on Jan. 29, 2016 which claims priority to Norway Patent Application 20150134, filed on Jan. 29, 2015, as filed with Patentstyret, the Norwegian Industrial Property Office, the entire contents which are herein incorporated by reference for all they teach and disclose.

### BACKGROUND

All publications cited in this application are herein incorporated by reference.

Soybean protein concentrate is widely used as functional or nutritional ingredient in a wide variety of food products, mainly in baked foods, breakfast cereals and in some meat products. Soy protein concentrate is used in meat and poultry products to increase water and fat retention, and to improve nutritional values (more protein, less fat) and is even used for some non-food applications.

The foregoing examples of the related art and limitations related therewith are intended to be illustrative and not exclusive. Other limitations of the related art will become apparent to those of skill in the art upon a reading of the specification.

### SUMMARY

The following embodiments and aspects thereof are described and illustrated in conjunction with products and methods, which are meant to be exemplary and illustrative, not limiting in scope. In various embodiments, one or more of the above-described problems have been reduced or eliminated, while other embodiments are directed to other improvements.

One embodiment discloses a method for processing soybean seed, wherein said method comprises the following sequential steps: a. soaking cracked, dehulled soybeans in water that is approximately 158 degrees Fahrenheit in temperature for thirty minutes; b. transferring the dehulled soybeans from step a. to water that is approximately 158 degrees Fahrenheit in temperature and soaking for ten minutes; c. increasing the temperature of said water to approximately 176 degrees Fahrenheit and soaking for ten minutes; d. increasing the temperature of said water to approximately 185 degrees Fahrenheit and soaking for ten minutes; e. removing the dehulled soybeans from said water; and f drying the dehulled soybeans from step e. at an air temperature not to exceed 185 degrees Fahrenheit to a soybean moisture content of 5% to 21%.

Another embodiment discloses a method for processing soybean seed, wherein said method comprises the following sequential steps: a. soaking cracked, dehulled soybeans in water that is approximately 158 degrees Fahrenheit in temperature for thirty minutes; b. draining the water from step a. and adding fresh water that is approximately 158 degrees Fahrenheit in temperature to the dehulled soybeans and soaking for ten minutes; c. increasing the temperature of said water to approximately 176 degrees Fahrenheit and soaking for ten minutes; d. increasing the temperature of said water to approximately 185 degrees Fahrenheit and soaking for ten minutes; e. removing the dehulled soybeans from said water; and f drying the dehulled soybeans from step e. at an air temperature not to exceed 185 degrees Fahrenheit to a moisture content of 5% to 21%.

### BRIEF DESCRIPTION OF THE FIGURES

FIG. 1 shows a flow diagram for processing soybean seed.

FIG. 2 shows a flow diagram for processing soybean seed.

### DEFINITIONS

Linoleic acid. Linoleic acid is an unsaturated omega-6 fatty acid and is a carboxylic acid with an 18-carbon chain and two cis double bonds. Linoleic acid belongs to one of the two families of essential amino acids, because it cannot be synthesized by the body.

Linolenic acid. Linolenic acid can refer to either of two octadecatrienoic acids, or a mixture of the two. For example, a-Linolenic acid is an essential omega-3 fatty acid and organic compound found in seeds, nuts, and many common vegetable oils.

Oleic acid. Oleic acid is a fatty acid that occurs naturally in various animal and vegetable fats and oils and is classified as a monounsaturated omega-9 fatty acid.

Oligosaccharide. An oligosaccharide means a saccharide containing three to ten components (rings).

Palmitic acid. Palmitic acid is commonly known as hexadecanoic acid and is the most common saturated fatty acid found in animals, plants and microorganisms.

Protein. A protein is any of various naturally occurring extremely complex substances that consist of amino-acid residues joined by peptide bonds, contain the elements carbon, hydrogen, nitrogen, oxygen, usually sulfur, and occasionally other elements (as phosphorus or iron), and include many essential biological compounds (such as enzymes, hormones, or antibodies).

Raffinose. Raffinose is a trisaccharide, 3-ringed molecule, composed of glucose, fructose, and galactose.

Stachyose. Stachyose is a tetrasaccharide, 4-ringed molecule, composed of glucose, fructose, and two galactose molecules.

Stearic acid. Stearic acid is a saturated fatty acid with an 18-carbon chain and is commonly known as octadecanoic acid.

Sucrose. Sucrose is a disaccharide composed of fructose and glucose (table sugar).

Trypsin. Trypsin is a digestive enzyme, specifically, a pancreatic serine protease enzyme with substrate specificity based upon positively charged lysine and arginine side chains and is excreted by the pancreas. Trypsin aids in the digestion of food proteins and other biological processes.

Trypsin inhibitor units. Trypsin inhibitor units or abbreviated as TIU, is an assay measuring the quantity of trypsin inhibitor in a soybean seed or soybean product thereof. Measurement of trypsin inhibitor units is a technique well-known in the art.

### DETAILED DESCRIPTION OF THE EMBODIMENTS

An embodiment of the present disclosure comprises a method for processing soybean seed, wherein said method comprises the following sequential steps: a. soaking cracked, dehulled soybeans in water that is approximately 158 degrees Fahrenheit in temperature for thirty minutes; b. transferring the dehulled soybeans from step a. to water that is approximately 158 degrees Fahrenheit in temperature and soaking for ten minutes; c. increasing the temperature of said water to approximately 176 degrees Fahrenheit and soaking for ten minutes; d. increasing the temperature of said water to approximately 185 degrees Fahrenheit and soaking for ten minutes; e. removing the dehulled soybeans from said water; and f drying the dehulled soybeans from step e. at an air temperature not to exceed 185 degrees Fahrenheit to a soybean moisture content of 5% to 21%. For clarity, the water in step b is different from the water in step a.

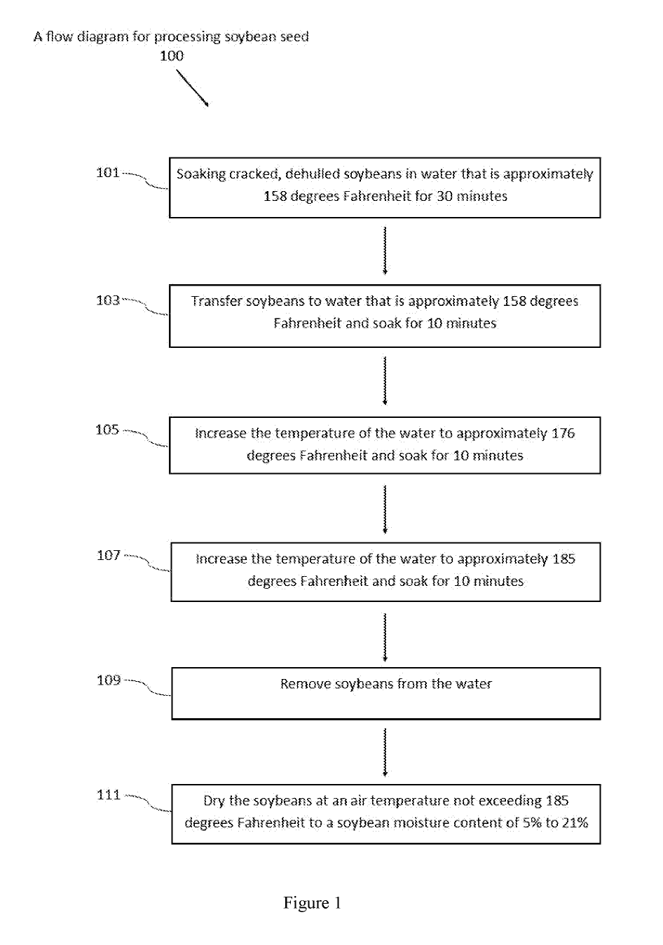

As shown in FIG. 1, a flow diagram for processing soybean seed 100 is provided in one embodiment. The steps below assume that the water and soybeans are put into a suitable tank or container. Equipment that can be used are tanks with mixers or screws where the cracked soybeans run continuously through one water bath. Step 101 shows soaking cracked, dehulled soybeans in water that is approximately 158 degrees Fahrenheit in temperature for thirty minutes. After this second step of soaking is completed, the leach water is high in carbohydrate molasses and anti-nutrient substances; these two types of products can be separated from each other and used for animal feed directly as there are no chemical residues. Step 103 shows transferring the dehulled beans from step 101 to water that is approximately 158 degrees Fahrenheit in temperature for ten minutes. Step 105 shows increasing the temperature of said water to approximately 176 degrees Fahrenheit for ten minutes. Step 107 shows increasing the temperature of said water to approximately 185 degrees Fahrenheit for ten minutes. Step 109 shows removing the dehulled soybeans from said water. Step 111 shows drying the dehulled soybeans from step 109 at an air temperature not to exceed 185 degrees Fahrenheit to a moisture content of 5% to 21%. This product is then extruded, pressed, ground, etc. to get a desired final product. Lipids may be removed conventionally using a press or via solvent such as hexane. Another embodiment of the above method may include agitating, mixing, or stirring the water and soybean mixture.

Another embodiment of the present disclosure discloses the method above, wherein the ratio of water to soybeans is 4:1 in step a and wherein the ratio of water to soybeans is 3:1 in step b.

Another embodiment of the present disclosure discloses the method above, wherein the steps consisting of a, b, c, d, and e can further comprise agitation, stirring, or mixing.

Another embodiment of the present disclosure discloses a soybean product produced by the method recited above, wherein said soybean product has a total amino acid content of 19% or greater when compared to unprocessed soybeans on a dry weight basis.

Another embodiment of the present disclosure discloses a soybean product produced by the method recited above, wherein said soybean product has an ash content of at least 34% less when compared to unprocessed soybeans.

Another embodiment of the present disclosure discloses a soybean product produced by the method recited above, wherein said soybean product has a total amino acid content of 19% or greater when compared to unprocessed soybeans on a dry weight basis.

Another embodiment of the present disclosure discloses a soybean product produced by the method recited above, wherein said soybean product has a 23% or greater total amino acid content when compared to unprocessed soybeans on a moist weight basis.

Another embodiment of the present disclosure discloses a soybean product produced by the method recited above, wherein said soybean product has at least a 54% reduction in the Potassium content when compared to unprocessed soybeans.

Another embodiment discloses a method for processing soybean seed, wherein said method comprises the following sequential steps: a. soaking cracked, dehulled soybeans in water that is approximately 158 degrees Fahrenheit in temperature for thirty minutes; b. draining the water from step a. and adding fresh water that is approximately 158 degrees Fahrenheit in temperature to the dehulled soybeans and soaking for ten minutes; c. increasing the temperature of said water to approximately 176 degrees Fahrenheit and soaking for ten minutes; d. increasing the temperature of said water to approximately 185 degrees Fahrenheit and soaking for ten minutes; e. removing the dehulled soybeans from said water; and f drying the dehulled soybeans from step e. at an air temperature not to exceed 185 degrees Fahrenheit to a moisture content of 5% to 21%.

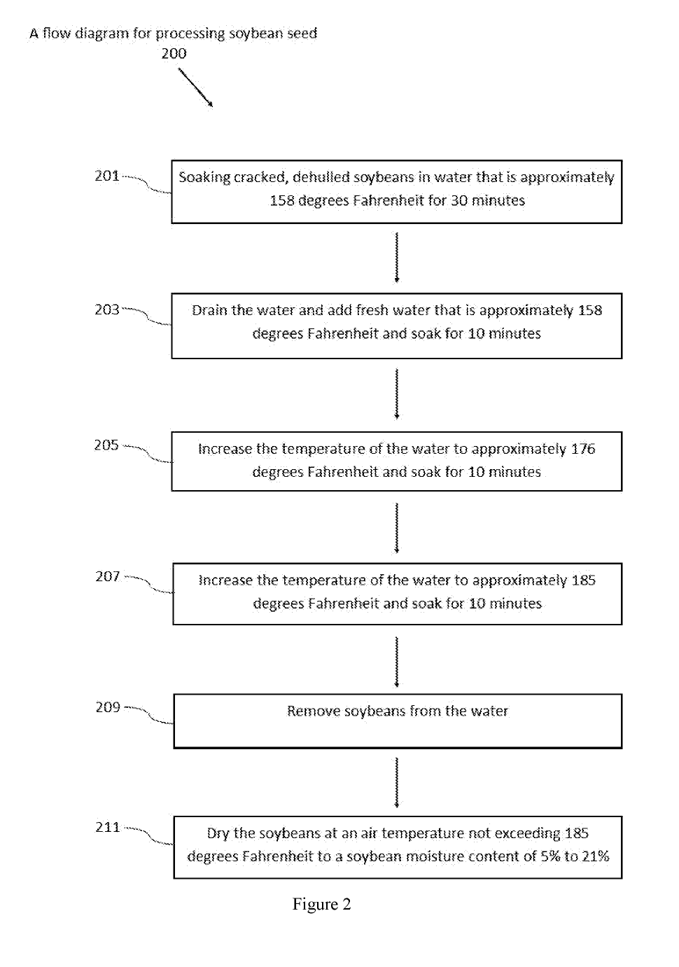

As shown in FIG. 2, a flow diagram for processing soybean seed 200 is provided in one embodiment. The steps below assume that the water and soybeans are put into a suitable tank or container. Equipment that can be used are tanks with mixers or screws where the cracked soybeans run continuously through one water bath. Step 201 shows soaking cracked, dehulled soybeans in water that is approximately 158 degrees Fahrenheit in temperature for thirty minutes. After this second step of soaking is completed, the leach water is high in carbohydrate molasses and anti-nutrient substances; these two types of products can be separated from each other and used for animal feed directly as there are no chemical residues. Step 203 shows transferring the dehulled beans from step 201 to water that is approximately 158 degrees Fahrenheit in temperature for ten minutes. Step 205 shows increasing the temperature of said water to approximately 176 degrees Fahrenheit for ten minutes. Step 207 shows increasing the temperature of said water to approximately 185 degrees Fahrenheit for ten minutes. Step 209 shows removing the dehulled soybeans from said water. Step 211 shows drying the dehulled soybeans from step 209 at an air temperature not to exceed 185 degrees Fahrenheit to a moisture content of 5% to 21%. This product is then extruded, pressed, ground, etc. to get a desired final product. Lipids may be removed conventionally using a press or via solvent such as hexane.

Another embodiment of the present disclosure discloses the method above, wherein the ratio of water to soybeans is 4:1 in step a and wherein the ratio of water to soybeans is 3:1 in Step b.

Another embodiment of the present discloses the method above, wherein the steps consisting of a, b, c, d, and e can further comprise agitation, stirring, or mixing.

Another embodiment of the present disclosure discloses a soybean product produced by the method recited above, wherein said soybean product has a total amino acid content of 19% or greater when compared to unprocessed soybeans on a dry weight basis.

Another embodiment of the present disclosure discloses a soybean product produced by the method recited above, wherein said soybean product has an ash content of at least 34% less when compared to unprocessed soybeans.

Another embodiment of the present disclosure discloses a soybean product produced by the method recited above, wherein said soybean product has a total amino acid content of 19% or greater when compared to unprocessed soybeans on a dry weight basis.

Another embodiment of the present disclosure discloses a soybean product produced by the method recited above, wherein said soybean product has a 23% or greater total amino acid content when compared to unprocessed soybeans on a moist weight basis.

Another embodiment of the present disclosure discloses a soybean product produced by the method recited above, wherein said soybean product has at least a 54% reduction in the Potassium content when compared to unprocessed soybeans.

Other embodiments of the processes above include that if the cracked and dehulled soybeans are washed or soaked as whole without flaking and pre-dried, they can still be rolled into flakes of about 2 mm to 4 mm. Nuclear flakes can then dried in a hot air or direct steam drier where the water content is taken down below 12%. The dried flakes can then transferred over to a mechanical screw press which presses the oil out of flake cores. In the press process can be used coolant in the mechanical press transport walls or screw or you can add CO₂ in the form of dry ice, which gas directly or supercritical CO₂. This will release some of the oil and cooling down somewhat by frictional heat that may arise. The final product typically contains 58% to 68% protein and having oil levels in flour of approximately 4% to 9%. The oil is in the flour will contribute biological energy and bind the flour so that no or a smaller amount of flour dust is created, which one common issue with protein flours. Further, if no solvent is used in the processing of the embodiments of this method, any final product will readily be adapted to organic production since it will not contain solvent.

### Soy Protein

Soy protein concentrates are prepared by removing soluble sugars from defatted soy flakes or flours. The remaining components are mainly proteins and insoluble polysaccharides.

By the removal of soluble sugars from defatted flakes, the protein content of the resulting soy product is increased and the undesirable oligosaccharides, which cause flatulence, are eliminated. During extraction, most sucrose and most nondigestible oligosaccharides consisting of stachyose, raffinose, and a small amount of other carbohydrates are not removed.

Different leaching methods are available to remove soluble sugars to yield soy protein concentrates. The basic method is to extract the sugars while not solubilizing the protein portion, so that as much protein is left in the concentrate as possible. The typical factors in leaching or fractionation that affect final soy protein content and product quality are the starting material (for example, the quality of the soybean), extracting solvent, and extracting conditions. Soy protein concentrate is most typically prepared from defatted flakes produced by using hexane as the oil-extracting solvent.

The temperature or temperatures employed during the preparation of defatted flakes impacts the overall yield of the final soy protein concentrate, as well as the quality of the final soy protein concentrate, as it is commonly known that excessive temperatures can destroy proteins.

Soybeans are grown for a number of uses, to be used in food and for meal, and oil is a secondary product. In order to begin processing the soybeans, the soybeans must first be cracked to remove the hull (that is, the soybeans are dehulled) and then rolled into full-fat flakes. The rolling process disrupts the oil cells, enabling the ultimate extraction of the soybean oil later in the process. The soybean oil is typically extracted using a solvent, such as hexane, although alternative ways of avoiding solvent extraction may use the well-known and common methods of hydraulic and screw presses. After the oil has been extracted, the solvent is removed, and the flakes are dried, creating defatted soy flakes. The defatted soybean flakes may be processed into soybean meal for animal or aquatic feeding or for human consumption, such as making tofu, soy flour, or as protein concentrates to be used in other soy based foods.

Soybean meal and oil also can be produced by the using extruders, where the whole or de-hulled soybeans at field moisture are fed continuously to a dry extruder. Within the extruder barrel, the material is subjected to friction and pressure, and heat is generated. The temperature profile within the extruder barrel can be varied depending upon the intended use of the processed meal. This process does not require an external heat source. Typically, the top temperature at the exit of the extruder barrel is can be high, however, lower temperature profiles are used when the meal is intended for use as a functional ingredient in food applications.

### Processes for Manufacturing Soy Protein Concentrate

The three common processes for manufacturing soy protein concentrate are aqueous alcohol wash, acid wash, and hot water leaching.

### Aqueous Alcohol Process

The aqueous alcohol process may be used to produce commercial soy protein concentrates, wherein soluble sugars, along with small amounts of soluble proteins are extracted using aqueous alcohol that is 50% to 70%. Proteins are denatured by the aqueous alcohol and stay with the insoluble polysaccharide because of insolubility. By using a flash desolventizing system, which is well-known in the art, any remaining alcohol can be removed.

### Acid Wash Process

The acid wash process is well-known in the art includes washing defatted soybean in a low pH to remove any undesirables, such as soluble sugars, and leaving behind the desirable proteins. Because some of the desired proteins may be soluble in the low pH, a reduction in protein concentration can result. This process may result in a final product with a high Nitrogen Solubility Index (NSI), a percentage of the protein nitrogen that is soluble when compared to the total percentage of protein nitrogen.

### Hot Water Leaching Process

Proteins may be easily denatured by heat and as a consequence of denaturing, may become insoluble in water. The use of high temperature water, up to 212 degrees Fahrenheit, can denature proteins and affect the protein quality and quantity of the final soybean concentrate product.

### Soybean Oil Content

Oilseeds generally contain from about 20% to about 50% oil by weight with the percentages varying with the type of oilseed. Often, oilseed meals are pressed to remove the majority of oil. However, even with pressing, a significant amount of oil remains in the meal. Oil content of the meal can be reduced to about 10-25% by mechanical processing (pressing) and then further processed using various solvents to reduce the oil content to about 3%. The pressed oilseed meal is generally removed using low-boiling organic solvents such as hexane. While these organic solvents can remove additional oil from the oil seed meals by extraction, the use of such organic solvents, even though they may be relatively low boiling, still require elevated temperatures for solvent removal. Elevated temperatures can result in denaturing of the protein, which degrades soluble protein resulting in increased levels of insoluble protein thereby reducing the nutritional value of the product. The use of solvent (other than water) may result in environmental issues, as well as recovery and disposal problems in addition to increased energy usage. Even when elevated temperatures are used, residual organic solvent is trapped within the solvent-extracted meal; this residual solvent is difficult to remove without denaturing the protein in the meal.

The methods above are the most common methods today for the production of protein concentrates from soybeans. The main processing disadvantage of obtaining the final protein concentrate product is the use of chemicals, especially hexane, which has been proven to have a negative effect on the nervous system of humans and animals. When hexane and ethanol are used, energy, in the form of high temperatures, is required for the solvents to be evaporated from the protein product which affects the biological quality of the protein. The consequences can be a less protein concentrated meal, for example, for carnivorous fish and land animals like chicken and piglets and pets, all of which are required to have high protein quality. The method described in the current application in that it removes components called anti-nutritional substances, while creating a very high protein concentrate and high amount of oil without the use of solvents.

### EXAMPLES

### Protocol for Processing of Soybeans Using the Method of the Present Application

### A. Drying, Dehulling, and Cracking Soybeans

Soybeans were dried, dehulled, and cracked according to methods well-known in the art. The cracked, dehulled, and dried soybeans can now either be further processed or they can be rolled into flakes with a thickness of 2 mm to 4 mm. Normal flakes thickness is +/−1 mm.

### B. Processing the Cracked, Dehulled, and Dried Soybeans or Flakes

As shown in FIG. 1, a flow diagram for processing soybean seed 100 is provided in one embodiment. The ratio of soybeans in the following steps to water is unique in that 1 part soybean to 3 or 4 parts water is used, whereas other methods use a ratio of 1 part soybeans to 10 parts water. The steps below assume that the water and soybeans are put into a suitable tank or container. Equipment that can be used are tanks with mixers or screws where the cracked soybeans run continuously through one water bath. Step 101 shows soaking cracked, dehulled soybeans in water that is approximately 158 degrees Fahrenheit in temperature for thirty minutes. Step 103 shows transferring the dehulled beans from step 101 to water that is approximately 158 degrees Fahrenheit in temperature and soaking for ten minutes. Step 105 shows increasing the temperature of said water to approximately 176 degrees Fahrenheit and soaking for ten minutes. Step 107 shows increasing the temperature of said water to approximately 185 degrees Fahrenheit and soaking for ten minutes. After this second step of soaking is completed, the leach water is high in carbohydrate molasses and anti-nutrient substances; these two types of products can be separated from each other and used for animal feed directly as there are no chemical residues. Step 109 shows removing the dehulled soybeans from said water. Step 111 shows drying the dehulled soybeans from step 109 at an air temperature not to exceed 185 degrees Fahrenheit to a moisture content of 5% to 21%. This product is then extruded, pressed, ground, etc. to get a desired final product. Lipids may be removed conventionally using a press. Solvents, such as hexane, may be used to remove lipids but are not necessary. Another embodiment of the above method may include agitating, mixing, or stirring the water and soybean mixture.

As shown in FIG. 2, a flow diagram for processing soybean seed 200 is provided in one embodiment. The ratio of soybeans in the following steps to water is unique in that 1 part soybean to 3 or 4 parts water is used, whereas other methods use a ratio of 1 part soybeans to 10 parts water. The steps below assume that the water and soybeans are put into a suitable tank or container. Equipment that can be used are tanks with mixers or screws where the cracked soybeans run continuously through one water bath. Step 201 shows soaking cracked, dehulled soybeans in water that is approximately 158 degrees Fahrenheit in temperature for thirty minutes. Step 203 shows transferring the dehulled beans from step 201 to water that is approximately 158 degrees Fahrenheit in temperature and soaking for ten minutes. Step 205 shows increasing the temperature of said water to approximately 176 degrees Fahrenheit and soaking for ten minutes. Step 207 shows increasing the temperature of said water to approximately 185 degrees Fahrenheit and soaking for ten minutes. After this second step of soaking is completed, the leach water is high in carbohydrate molasses and anti-nutrient substances; these two types of products can be separated from each other and used for animal feed directly as there are no chemical residues. Step 209 shows removing the dehulled soybeans from said water. Step 211 shows drying the dehulled soybeans from step 209 at an air temperature not to exceed 185 degrees Fahrenheit to a moisture content of 5% to 21%. This product is then extruded, pressed, ground, etc. to get a desired final product. Lipids may be removed conventionally using a press. Solvents, such as hexane, may be used to remove lipids but are not necessary. Another embodiment of the above method may include agitating, mixing, or stirring the water and soybean mixture.

Other embodiments of the processes above include that if the cracked and dehulled soybeans are washed or soaked as whole without flaking and pre-dried, they can still be rolled into flakes of about 2 mm to 4 mm. Nuclear flakes can then dried in a hot air or direct steam drier where the water content is taken down below 12%. The dried flakes can then transferred over to a mechanical screw press which presses the oil out of flake cores. In the press process can be used coolant in the mechanical press transport walls or screw or you can add CO₂ in the form of dry ice, which gas directly or supercritical CO₂. This will release some of the oil and cooling down somewhat by frictional heat that may arise. The final product typically contains 58% to 68% protein and having oil levels in flour of approximately 4% to 9%. The oil is in the flour will contribute biological energy and bind the flour so that no or a smaller amount of flour dust is created, which one common issue with protein flours. Further, if no solvent is used in the processing of the embodiments of this method, any final product will readily be adapted to organic production since it will not contain solvent.

Analysis of Soybean Meal Derived from Process Described in the Present Application
I. Comparison on an “as is” Basis (Moisture Not Removed)

In January 2016, two lines of soybeans were processed using the methods disclosed in the present application, termed “Nexoy” below, compared to the soybean processing method disclosed in U.S. Pat. No. 3,971,856. 4575 is a Schillinger Genetics, Inc. soybean variety. A commodity soybean variety was used for a comparison between the two processing methods. The processing method described in U.S. Pat. No. 3,971,856 was run in two different temperatures, 180 degrees Fahrenheit and 212 degrees Fahrenheit. Soybean components were subsequently analyzed using methods well-known in the art. The results of this analysis are shown in Table 1. Column one shows the component, columns 2-5 show the component results from using soybean variety 4575 in the process as described in U.S. Pat. No. 3,971,856 at 180 degrees Fahrenheit (column 2) and 212 degrees Fahrenheit (column 3), with the Nexoy process (column 4) and a control (in column 5, where the soybeans were analyzed as is without undergoing further processing or being unprocessed) and columns 6-9 show the component results from using a commodity soybean variety in the process as described in U.S. Pat. No. 3,971,856 at 180 degrees Fahrenheit (column 6) and 212 degrees Fahrenheit (column 7), with the Nexoy process (column 8) and a control (in column 9, where the soybeans were analyzed as is without undergoing further processing). All numbers are percentages based on an “as is” basis (that is, not on a dry basis, where moisture is not removed). The last row in the table shows the “Total AA”, which is a summary of the total percentages of amino acids for the trial in each column.

TABLE 1
Analysis of 4575 and commodity soybean variety with Nexoy process versus
process in U.S. Pat. No. 3,971,856 - “as is” basis

| | Soybean | | | | | | | |
|---|---|---|---|---|---|---|---|---|
| | 4575 | | | | Commodity soybean | | | |
| Component | 180 | 212 | Nexoy | Control | 180 | 212 | Nexoy | Control |
| Moisture | 6.48 | 6.92 | 5.81 | 9.30 | 7.06 | 8.54 | 5.36 | 8.44 |
| Protein | 55.41 | 55.17 | 55.79 | 46.74 | 43.68 | 43.38 | 46.14 | 37.67 |
| Fat | 21.33 | 21.32 | 22.52 | 16.08 | 26.69 | 26.57 | 27.30 | 20.70 |
| Crude Fiber | 1.8 | 2.1 | 2.4 | 2.9 | 2.4 | 2.1 | 2.0 | 3.5 |
| Ash | 3.80 | 3.66 | 3.47 | 5.21 | 3.46 | 3.38 | 3.22 | 5.08 |
| TIU | 1700 | 1500 | 1700 | 3500 | 2600 | 1900 | 3600 | 2100 |
| * Tryptophan | 0.77 | 0.77 | 0.79 | 0.65 | 0.65 | 0.66 | 0.68 | 0.54 |
| * Cysteine | 0.70 | 0.69 | 0.68 | 0.63 | 0.59 | 0.59 | 0.60 | 0.54 |
| * Methionine | 0.77 | 0.76 | 0.78 | 0.63 | 0.64 | 0.64 | 0.66 | 0.56 |
| * Alanine | 2.39 | 2.42 | 2.48 | 1.99 | 1.98 | 1.97 | 2.13 | 1.68 |
| * Arginine | 4.41 | 4.39 | 4.51 | 3.81 | 3.29 | 3.26 | 3.55 | 2.81 |
| * Aspartic Acid | 6.58 | 6.61 | 6.85 | 5.52 | 5.21 | 5.20 | 5.61 | 4.45 |
| * Glutamic Acid | 10.95 | 11.0 | 11.34 | 9.17 | 8.39 | 8.27 | 9.00 | 7.07 |
| * Glycine | 2.39 | 2.40 | 2.45 | 1.99 | 1.94 | 1.92 | 2.06 | 1.65 |
| * Histidine | 1.50 | 1.50 | 1.54 | 1.25 | 1.22 | 1.21 | 1.32 | 1.04 |
| * Isoleucine | 2.78 | 2.67 | 2.76 | 2.24 | 2.17 | 2.13 | 2.36 | 1.78 |
| * Leucine | 4.45 | 4.48 | 4.61 | 3.66 | 3.58 | 3.55 | 3.91 | 2.98 |
| * Phenylalanine | 3.02 | 3.02 | 3.11 | 2.50 | 2.34 | 2.31 | 2.54 | 1.96 |
| * Proline | 3.00 | 3.01 | 3.08 | 2.48 | 2.37 | 2.31 | 2.53 | 1.97 |
| * Serine | 2.82 | 3.01 | 3.10 | 2.41 | 2.35 | 2.35 | 2.46 | 1.99 |
| * Threonine | 2.16 | 2.20 | 2.26 | 1.80 | 1.82 | 1.82 | 1.93 | 1.52 |
| * Total Lysine | 3.72 | 3.76 | 3.76 | 3.01 | 3.07 | 2.95 | 3.30 | 2.49 |
| * Tyrosine | 1.99 | 1.99 | 2.03 | 1.62 | 1.61 | 1.59 | 1.73 | 1.32 |
| * Valine | 2.91 | 2.81 | 2.88 | 2.34 | 2.28 | 2.24 | 2.48 | 1.87 |
| Total AA | 57.31 | 57.49 | 59.01 | 47.7 | 45.5 | 44.97 | 48.85 | 38.22 |

a. Protein Comparison of Table 1

Results show that for each process, the amount of final protein the meal or protein concentrate increased when compared to soybeans that had not undergone either process. For 4575, the differences in final protein content between the method of U.S. Pat. No. 3,971,856 at 180 degrees Fahrenheit (column 2) and 212 degrees Fahrenheit (column 3) were comparable to the final protein content using the Nexoy method of the present application (column 4). However, there was a 6.36% to 5.63% increase in final protein content using the Nexoy method (column 8) over the method of U.S. Pat. No. 3,971,856 at 180 degrees Fahrenheit (column 6) and 212 degrees Fahrenheit (column 7) when using commodity soybeans. For the commodity soybean, the Nexoy method resulted in an increase in 22.48% more protein than the control, while the method recited in U.S. Pat. No. 3,971,856 at 180 degrees Fahrenheit and 212 degrees Fahrenheit resulted in a 15.16% to 15.95% increase in protein than the control. Both processes increased the amount of final protein content when compared to soybeans that had not undergone either process (column 9).

b. Ash Comparison of Table 1

When the results for ash is compared between the two varieties of soybeans and processes, there was less ash in the final protein concentrate for the Nexoy process when compared to the ash content of the final protein concentrate from the method of U.S. Pat. No. 3,971,856 at 180 degrees Fahrenheit and 212 degrees Fahrenheit. For 4575, the Nexoy process resulted in 5.19% to 8.68% less ash content than of the protein concentrate produced by the method of U.S. Pat. No. 3,971,856. For the commodity soybean, the Nexoy process resulted in 4.73% to 6.94% less ash content than of the protein concentrate produced by the method of U.S. Pat. No. 3,971,856. Alternatively, for 4575 the Nexoy process resulted in a 33.4% decrease in ash content when compared to the control, while the method recited in U.S. Pat. No. 3,971,856 at 180 degrees Fahrenheit and 212 degrees resulted in a 27.06% and 29.75% decrease in ash when compared to the control; for the commodity soybean, the Nexoy process resulted in a 36.61 decrease in ash when compared to the control, while the method recited in U.S. Pat. No. 3,971,856 at 180 degrees Fahrenheit and 212 degrees resulted in a 31.89% and 33.46% decrease in ash when compared to the control. The Nexoy process resulted in a significantly greater decrease in ash than the comparison method in in U.S. Pat. No. 3,971,856. This is significant result for the final protein concentrate in that the amount of ash for example, an aquaculture diet, should be kept low in an overall diet so as not to affect the digestibility of the diet (ash has the same or similar effects of fiber).

c. Amino Acid Comparison of Table 1

Amino acids are an important profile of testing soybeans because typically the higher the amino acid profile of a soybean and soybean meal, particularly of lysine and methionine which are digestible, allow for a higher density and greater quality meal and cysteine and threonine. For soybean variety 4575, when comparing the total percentage of amino acids between the Nexoy process and the control, the Nexoy process produced a final soybean concentrate that had a 23.71% greater composition of amino acids than the control, while the method of U.S. Pat. No. 3,971,856 produced a final soybean concentrate that had a 20.15% to 20.52% greater composition of amino acids than the control. For the commodity soybean, when comparing the total percentage of amino acids between the Nexoy process and the control the Nexoy process produced a final soybean concentrate that had a 27.81% greater composition of amino acids than the control, while the method of U.S. Pat. No. 3,971,856 produced a final soybean concentrate that had a 17.66% to 19.05% greater composition of amino acids than the control. Moreover, when the Nexoy process is compared to the method of U.S. Pat. No. 3,971,856 at 180 degrees Fahrenheit and 212 degrees Fahrenheit, the Nexoy process results in a 2.64% and 2.97% increase for soybean variety 4575 and a 7.36% and 8.63% increase for the commodity soybean.

When comparing the percentages of cysteine, methionine, threonine, and total lysine between the two processing methods, the percentage of lysine was significantly higher in the commodity soybean using the Nexoy process, 32.53% higher than the control, when compared to the method of U.S. Pat. No. 3,971,856 at 180 degrees Fahrenheit and 212 degrees Fahrenheit, 18.47% to 23.29% higher than the control. Lysine is a significant and important component of soybean and soybean meal in that it is a limiting amino acid and therefore, a higher content of lysine is a desirable aspect of quality in the final food product.

### II. Comparison Based on a “Dry” Basis (Moisture Removed)

In January 2016, two lines of soybeans were processed using the methods disclosed in the present application, termed “Nexoy” below, compared to the soybean processing method disclosed in U.S. Pat. No. 3,971,856. 4575 is a Schillinger Genetics, Inc. soybean variety. A commodity soybean variety was used for a comparison between the two processing methods. The processing method described in U.S. Pat. No. 3,971,856 was run in two different temperatures, 180 degrees Fahrenheit and 212 degrees Fahrenheit. Soybean components were subsequently analyzed using methods well-known in the art. The results of this analysis are shown in Table 2. Column one shows the component, columns 2-5 show the component results from using soybean variety 4575 in the process as described in U.S. Pat. No. 3,971,856 at 180 degrees Fahrenheit (column 2) and 212 degrees Fahrenheit (column 3), with the Nexoy process (column 4) and a control (in column 5, where the soybeans were analyzed as is without undergoing further processing, or being unprocessed) and columns 6-9 show the component results from using a commodity soybean variety in the process as described in U.S. Pat. No. 3,971,856 at 180 degrees Fahrenheit (column 6) and 212 degrees Fahrenheit (column 7), with the Nexoy process (column 8) and a control (in column 9, where the soybeans were analyzed as is without undergoing further processing). All numbers are percentages based on a “dry” basis (that is, no moisture). The last row in the table shows the “Total AA”, which is a summary of the total percentages of amino acids for the trial in each column.

TABLE 2
Analysis of 4575 and commodity soybean variety with Nexoy process versus
process in U.S. Pat. No. 3,971,856

| | Soybean | | | | | | | |
|---|---|---|---|---|---|---|---|---|
| | 4575 | | | | Commodity soybean | | | |
| Component | 180 | 212 | Nexoy | Control | 180 | 212 | Nexoy | Control |
| Protein | 59.25 | 59.27 | 59.23 | 51.53 | 47.00 | 47.43 | 48.75 | 41.15 |
| Fat | 22.81 | 22.91 | 23.91 | 17.73 | 28.72 | 29.05 | 28.84 | 22.61 |
| Crude Fiber | 1.90 | 2.30 | 2.50 | 3.20 | 2.60 | 2.30 | 2.10 | 3.80 |
| Ash | 4.06 | 3.93 | 3.68 | 5.74 | 3.72 | 3.69 | 3.40 | 5.55 |
| TIU | 1818 | 1612 | 1805 | 3859 | 2798 | 2077 | 3804 | 2294 |
| * Tryptophan | 0.83 | 0.82 | 0.84 | 0.71 | 0.70 | 0.72 | 0.72 | 0.59 |
| * Cysteine | 0.75 | 0.74 | 0.72 | 0.69 | 0.64 | 0.64 | 0.64 | 0.59 |
| * Methionine | 0.82 | 0.82 | 0.83 | 0.73 | 0.69 | 0.70 | 0.70 | 0.61 |
| * Alanine | 2.56 | 2.60 | 2.64 | 2.20 | 2.13 | 2.15 | 2.25 | 1.83 |
| * Arginine | 4.71 | 4.71 | 4.79 | 4.20 | 3.54 | 3.56 | 3.75 | 3.07 |
| * Aspartic Acid | 7.03 | 7.10 | 7.27 | 6.09 | 5.61 | 5.68 | 5.93 | 4.86 |
| * Glutamic Acid | 11.71 | 11.81 | 12.04 | 10.11 | 9.03 | 9.05 | 9.51 | 7.72 |
| * Glycine | 2.56 | 2.58 | 2.60 | 2.19 | 2.08 | 2.10 | 2.18 | 1.80 |
| * Histidine | 1.61 | 1.61 | 1.63 | 1.38 | 1.31 | 1.32 | 1.40 | 1.14 |
| * Isoleucine | 2.97 | 2.87 | 2.93 | 2.47 | 2.33 | 2.33 | 2.49 | 1.95 |
| * Leucine | 4.76 | 4.82 | 4.90 | 4.04 | 3.85 | 3.88 | 4.13 | 3.26 |
| * Phenylalanine | 3.23 | 3.25 | 3.31 | 2.75 | 2.52 | 2.53 | 2.68 | 2.14 |
| * Proline | 3.21 | 3.24 | 3.26 | 2.73 | 2.55 | 2.53 | 2.67 | 2.15 |
| * Serine | 3.01 | 3.23 | 3.29 | 2.66 | 2.53 | 2.57 | 2.60 | 2.17 |
| * Threonine | 2.31 | 2.37 | 2.40 | 1.99 | 1.96 | 1.99 | 2.04 | 1.66 |
| * Total Lysine | 3.98 | 4.04 | 3.99 | 3.32 | 3.30 | 3.23 | 3.48 | 2.72 |
| * Tyrosine | 2.13 | 2.14 | 2.15 | 1.79 | 1.73 | 1.74 | 1.83 | 1.44 |
| * Valine | 3.11 | 3.02 | 3.06 | 2.58 | 2.46 | 2.45 | 2.62 | 2.04 |
| Total AA | 61.29 | 61.77 | 62.65 | 52.63 | 48.96 | 49.17 | 51.62 | 41.74 |

a. Protein Comparison of Table 2

Results show that for each process, the amount of final protein the meal or protein concentrate increased when compared to soybeans that had not undergone either process. For 4575, the differences in final protein content between the method of U.S. Pat. No. 3,971,856 at 180 degrees Fahrenheit (column 2) and 212 degrees Fahrenheit (column 3) were comparable to the final protein content using the Nexoy method of the present application (column 4). However, there was a 2.78% to 3.72% increase in final protein content using the Nexoy method (column 8) over the method of U.S. Pat. No. 3,971,856 at 180 degrees Fahrenheit (column 6) and 212 degrees Fahrenheit (column 7) when using commodity soybeans. Both processes increased the amount of final protein content when compared to soybeans that had not undergone either process (column 9). Alternatively, for the commodity soybean, the Nexoy process resulted in an 18.47% increase in protein when compared to the control, while the method recited in U.S. Pat. No. 3,971,856 at 180 degrees Fahrenheit and 212 degrees Fahrenheit resulted in a 14.22% and 15.26% increase in protein when compared to the control.

b. Ash Comparison of Table 2

When the results for ash is compared between the two varieties of soybeans and processes, there was less ash in the final protein concentrate for the Nexoy process when compared to the ash content of the final protein concentrate from the method of U.S. Pat. No. 3,971,856 at 180 degrees Fahrenheit and 212 degrees Fahrenheit. For 4575, the Nexoy process resulted in 35.89% less ash content than that of the control, when compared to the method of U.S. Pat. No. 3,971,856 which resulted in 29.27% to 31.53% less ash than the control. For the commodity soybean, the Nexoy process resulted in 38.74% less ash than the control, when compared to the method of U.S. Pat. No. 3,971,856 which resulted in 32.97% to 33.51% less ash than the control. Moreover, when the Nexoy process is compared to the method of U.S. Pat. No. 3,971,856 at 180 degrees Fahrenheit and 212 degrees Fahrenheit, the Nexoy process results in a 6.36% and 9.36% decrease for soybean variety 4575 and a 7.86% and 8.60% decrease for the commodity soybean. This is significant for the final protein concentrate in that the amount of ash in for example, an aquaculture diet, should be kept low in an overall diet so as not to affect the digestibility of the diet (ash has the same or similar effects of fiber).

c. Amino Acid Comparison of Table 2

Amino acids are an important profile of testing soybeans because typically the higher the amino acid profile of a soybean and soybean meal, particularly of lysine and methionine which are digestible, allow for a higher density and greater quality meal and cysteine and threonine. For soybean variety 4575, when comparing the total percentage of amino acids between the Nexoy process and the control the Nexoy process produced a final soybean concentrate that had an 19.04% greater composition of amino acids than the control, while the method of U.S. Pat. No. 3,971,856 produced a final soybean concentrate that had a 16.45% to 17.37% greater composition of amino acids than the control. For the commodity soybean, when comparing the total percentage of amino acids between the Nexoy process and the control the Nexoy process produced a final soybean concentrate that had a 23.67% greater composition of amino acids than the control, while the method of U.S. Pat. No. 3,971,856 produced a final soybean concentrate that had a 17.3% to 17.8% greater composition of amino acids than the control. Moreover, when the Nexoy process is compared to the method of U.S. Pat. No. 3,971,856 at 180 degrees Fahrenheit and 212 degrees Fahrenheit, the Nexoy process results in a 1.44% and 2.22% increase for soybean variety 4575 and a 4.98% and 5.43% increase for the commodity soybean.

When comparing the percentages of cysteine, methionine, threonine, and total lysine between the two processing methods, the percentage of lysine was higher in the commodity soybean using the Nexoy process, 27.94% higher than the control, while the method of U.S. Pat. No. 3,971,856 at 180 degrees Fahrenheit and 212 degrees Fahrenheit was 18.75% to 21.32% higher than the control. Lysine is a significant and important component of soybean and soybean meal in that it is a limiting amino acid and therefore, a higher content of lysine is a desirable aspect of quality in the final food product.

### III. Analysis of Potassium

Table 3 shows the Potassium concentration as a percentage of the overall component that was analyzed in the commodity sample from Tables 1-2 using the Nexoy method, the 4575 sample from Tables 1-2 using the Nexoy method, and the control 4575 sample from Tables 1-2. Potassium levels were analyzed using methods well-known in the art. Potassium levels in soybean meal are commonly in the area of 2.5% or higher. Low potassium levels are desirable in final food-products because having high potassium levels in food products is known to have a diuretic effect. In Table 3, column one shows the sample and method used, column 2 shows the Potassium level in the “as is” sample, and column 3 shows the Potassium level on a dry basis. As can be seen in Table 3, when the 4575 processed sample is compared to the 4575 control sample, there is a 54.03% reduction in Potassium levels. Although a control sample comparison for Potassium was not run for the commodity meal, using the average Potassium level of 2.5% found in commodity soybeans, it can be inferred that the Nexoy process also would theoretically result in a significant reduction in Potassium levels in the commodity sample when compared to a control.

TABLE 3
Comparison of Potassium levels in select samples

| | Potassium percentage | |
|---|---|---|
| Sample and method | “As is” basis | Dry basis |
| Commodity soybean sample | 0.86 | 0.91 |
| using Nexoy method | | |
| 4575 soybean sample using | 0.92 | 0.97 |
| Nexoy method | | |
| 4575 control sample | 1.91 | 2.11 |

### IV. Analysis of Saponins

In soybeans and soybean meal, saponins are anti-nutrients which have foaming properties. The presence of saponins are not desirable in soybeans and soybean meal. In Table 4, saponins were measured as sopogenols using methods well-known in the art. Saponin composition was measured in 4575 and e2854 (a Schillinger commercial soybean line) soybean samples that went through the Nexoy process, as described in the methods above and in the previous Examples in October 2015. Saponin levels in soybean meal are commonly in the range of 0.43% to 0.83% (Ireland et al., 1986. Saponin content of soya and some commercial soya products by means of high performance liquid chromatography of the sapogenins. Journal of the Science of Food and Agriculture. 37:694-698; Goda et al., 2002. Comparison of soyasaponin and isoflavone contents between genetically modified (GM) and non-GM soybeans. Journal of the Food Hyienics Society of Japan. 43:339-347). As can be shown in Table 4, the total saponin levels for each sample prepared using the Nexoy process are significantly lower than the averages stated above.

TABLE 4
Analysis of Saponin levels

| | Saponin percentage (total weight/weight) | |
|---|---|---|
| Sample and method | “As is” basis | Dry basis |
| 4575 using the Nexoy | 0.0861 | 0.1009 |
| method | | |
| e2854 using the Nexoy | 0.230 | 0.252 |
| method | | |

### Protein Content of Soybeans

Soybean protein is one of the highest quality of plant sources of protein. Soybean is made from soybean meal that have been dehulled and defatted. The amount of protein present in soybean seed is important because if the amount of protein can be increased, then the nutritional quality of the soybean itself, as well as other soybean products derived therefrom, can be increased.

### Raffinose and Stachyose

Raffinose family oligosaccharides, i.e., raffinose, stachyose, and verbascose (and also known as RFOs), are an obstacle to the efficient utilization of some economically important crop species. Raffinose and stachyose are not digested directly by animals, primarily because a-galactosidase is not present in the intestinal mucosa. Gitzelmann and Auricchio, Pediatrics, 36:231-236 (1965); Rutloff, et al., Nahrung, 11:39-46 (1967). However, microflora in the lower gut are readily able to ferment the raffinose and stachyose which results in an acidification of the gut and production of carbon dioxide, methane and hydrogen. Murphy, et al., J. Agr. Food Chem., 20:813-817 (1972); Cristofaro, et al., In Sugars in Nutrition, Chapter 20, 313-335 (1974); Reddy, et al., J. Food Science, 45:1161-1164 (1980). The presence of raffinose and stachyose restricts the use of soybeans in animal, including human, diets because otherwise this species is an excellent source of protein and fiber. In contrast to their potential for promoting germination, RFOs represent anti-nutritional units for monogastric animals when consumed as a component of feed.

Sucrose and RFOs are the most abundant of the soluble sugars (Peterbauer T, Richter., Biochemistry and physiology of raffinose family oligosaccharides and galactosyl cyclitols in seeds. Seed Science Research., (11): 185-197(2001)), but account for only a small portion of the total carbohydrates present in the seeds (Ziegler, P., Seed development and germination. Marcel Dekker Inc., New York (1995)). The problems and costs associated with RFOs could be reduced or eliminated through the availability of genes that confer a reduction of RFO content of soybean seeds. Such genes could be used to develop soybean varieties having inherently reduced and ultra-low levels of raffinose and stachyose seed content. Soybean varieties with an ultra-low RFO content would improve the nutritional quality of derived soy protein products and reduce processing costs associated with the removal of RFOs. Thus, soybean varieties with an ultra-low RFO content would be more valuable than conventional varieties for animal and human diets.

The key step in raffinose and stachyose biosynthesis is mediated by the enzyme raffinose synthase. The raffinose synthase enzyme belongs to a group of hydrolase family enzymes that execute a galactosyl transfer from galactinol to sucrose. This transfer produces the three ring molecule raffinose; myo-inositol is formed as a by-product. Similarly, stachyose is formed by the action of stachyose synthase which combines raffinose and galactinol. Thus, raffinose synthase and stachyose synthase share one identical substrate, galactinol, and a second similar substrate, sucrose or raffinose, respectively. It is not known if raffinose synthase and stachyose synthase have overlapping enzymatic activity in soybean. Please see U.S. Pat. No. 8,471,107 for additional information on raffinose and stachyose, which is incorporated herein in its entirety.

### Oleic Acid

Oleic acid is a monounsaturated acid and having a higher level of oleic acid is beneficial for multiple reasons. Trans fatty acids are increasingly becoming unpopular. By increasing the oleic acid content in soybeans, oils and fats produced from soybeans can be produced at high temperatures without the formation of trans fats. Please see U.S. Publication Nos. 2011/0010791 and 2012/0192306 for detailed descriptions on methods for achieving high oleic acid levels in soybeans.

### Trypsin

Trypsin is an important digestive enzyme, particularly in certain species where ancillary enzymes, such as pepsin and chymotrypsin are present in relatively small amounts, or are absent. From an economic standpoint, the most important of these species are chickens, pigs, and calves (when the calves are sufficiently young that they have not developed a fully mature digestive system). In such animals, in particular, if the enzyme trypsin is in some way impaired in its functioning, there are a number of deleterious results. First, any food which is ingested by the animal is lowered in nutritive value because of a directly impaired capacity to digest it. Second, even in animals which contain other digestive enzymes in addition to trypsin, trypsin normally activates some of these enzymes and allows their participation in the process. A deficiency in trypsin thus results in a concomitant deficiency in these enzymes. Finally, in response to a perceived lack of adequate trypsin, the pancreas is induced to release more trypsin than it is easily capable of releasing, resulting in an “overwork” condition called pancreatic hypertrophy, which at best, results in morbidity and at worst, in death.

Kunitz trypsin inhibitor is an anti-nutritional and allergenic factor in soybeans that interferes with digestion and absorption of proteins when present in a diet. Genetic and biochemical studies of Kunitz trypsin inhibitor production in soybean lines have been carried out (please see for example de Moraes, R. M. A., et al., “Assisted selection by specific DNA markers for genetic elimination of the kunitz trypsin inhibitor and lectin soybean seeds. Euphytica, 149:221-226 (2006) and Natarajan, S., et al., J. of Plant Physiol., 164(6): 756-763 (2007)), and three related genes have been identified, with KTI3 encoding the predominant Kunitz trypsin inhibitor protein in cultivated soybean genotypes (Natarajan et al., 2006). Some specific DNA markers associated with loss of Kunitz production in certain soybean lines have been reported (de Moraes, R. M. A., et al., 2006).

The Kunitz phenotype refers to a specific trypsin inhibitor and is responsible for a reduction in total trypsin inhibition (measured in TIU, trypsin inhibitor units) by roughly a third the level of commercially available soybeans. The unique phenotype of the instant application is an additional, stepwise, reduction in total trypsin inhibitor. It is likely that this reduction is the response to a mutation or mutations in other trypsin inhibitors, such as the Bowman-Burk trypsin inhibitors.

The Bowman-Birk trypsin inhibitors represent a group of soybean trypsin inhibitors that are genetically distinct from the Kunitz trypsin inhibitors. There are thought to be 6 to 10 different genes belonging to the Bowman-Birk class of inhibitors in soybeans, some mutants of which have been investigated (e.g., Livingstone, et al., Plant Mol. Biol., 64:397-408 (2007). The Bowman-Birk inhibitors appear to make up most of the remaining 65-70% of trypsin inhibitor activity not accounted for by the Kunitz trypsin inhibitors.

Trypsin inhibition is an insurmountable problem when the ingested foodstuff contains large quantities of soybean materials which have not been subjected to proper treatment to destroy a soybean trypsin inhibitor which is capable of binding the endogenous trypsin in the animal ingesting the foodstuff, and in preventing it from carrying out its normal function. Hence, animal foods which are largely soybean based are currently treated by “cooking” to inactivate this protein. In conventional soy processing, the soybeans are dehulled using a wet process, wherein the water content, however, is purposely limited in order to reduce waste weight and in order to prevent interference with subsequent processing steps. The hulled soybeans are then extracted with hexane to remove the soybean oil for commercial use. After the hexane extraction, the soybean mulch is heated to inactivate the soybean trypsin inhibitor.

This inactivation process is conducted at considerable expense, and with imperfect results. The heating produces a decline in soybean trypsin inhibitor content. Therefore, after a time period which is optimum for the particular preparation in question, further heating becomes uneconomical and counterproductive, even though additional amounts of soybean trypsin inhibitor would be thereby inactivated. The resulting processed soybean meal is then used in animal feeds in a variety of forms, and is reduced in soybean trypsin inhibitor but still contains residual amounts. Please see U.S. Patent Publication No. 2012031675 for additional information on trypsin, the contents of which are hereby incorporated by reference in their entirety.

### Additional Fatty Acids in Soybean

Palmitic, linolenic, linoleic and stearic acid are additional important fatty acids that make up the composition of soybean and soybean products therefrom. These fatty acids are well-known in the art and modification of their levels in soybeans and soybean products is desired from both agronomic and commercial standpoints.

### Commercial Use of Soybean and Soybean Products

Industrial uses of soybean oil which is subjected to further processing include ingredients for paints, plastics, fibers, detergents, cosmetics, lubricants, and biodiesel fuel. Soybean oil may be split, inter-esterified, sulfurized, epoxidized, polymerized, ethoxylated, or cleaved. Designing and producing soybean oil derivatives with improved functionality and improved oliochemistry is a rapidly growing field. The typical mixture of triglycerides is usually split and separated into pure fatty acids, which are then combined with petroleum-derived alcohols or acids, nitrogen, sulfonates, chlorine, or with fatty alcohols derived from fats and oils.

Soybean is also used as a food source for both animals, aquaculture, and humans. Soybean is widely used as a source of protein for animal feeds for poultry, swine and cattle.

For human consumption soybean meal is made into soybean flour which is processed to protein concentrates used for meat extenders, aquaculture, or specialty pet foods. Production of edible protein ingredients from soybean offers a healthier, less expensive replacement for animal protein in meats as well as in dairy-type products.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for processing soybean seed, wherein said method comprises the following sequential steps:
a. Soaking cracked, dehulled soybeans in water that is approximately 158 degrees Fahrenheit for thirty minutes;
b. Transferring the dehulled beans from step a. to water that is approximately 158 degrees Fahrenheit and soaking for ten minutes;
c. Increasing the temperature of said water to approximately 176 degrees Fahrenheit and soaking for ten minutes;
d. Increasing the temperature of said water to approximately 185 degrees Fahrenheit and soaking for ten minutes;
e. Removing the dehulled soybeans from said water; and
f. Drying the dehulled soybeans from step e. at an air temperature not to exceed 185 degrees Fahrenheit to a moisture content of 5% to 21%.

2. Step a. of the method of claim 1, wherein the ratio of water to soybeans is 4:1.

3. Step b. of the method of claim 1, wherein the ratio of water to soybeans is 3:1.

4. A method for processing soybean seed, wherein said method comprises the following sequential steps:
a. Soaking cracked, dehulled soybeans in water that is approximately 158 degrees Fahrenheit for thirty minutes;
b. Draining the water from step a. and adding fresh water that is approximately 158 degrees Fahrenheit to the dehulled beans and soaking for ten minutes;
c. Increasing the temperature of said water to approximately 176 degrees Fahrenheit and soaking for ten minutes;
d. Increasing the temperature of said water to approximately 185 degrees Fahrenheit and soaking for ten minutes;
e. Removing the dehulled soybeans from said water; and
f. Drying the dehulled soybeans from step e. at an air temperature not to exceed 185 degrees Fahrenheit to a moisture content of 5% to 21%.

5. Step a. of the method of claim 4, wherein the ratio of water to soybeans is 4:1.

6. Step b. of the method of claim 4, wherein the ratio of water to soybeans is 3:1.

7. The soybean product produced by the method of claim 1, wherein said soybean product has a protein content of 16% or greater when compared to unprocessed soybeans.

8. The soybean product produced by the method of claim 4, wherein said soybean product has a protein content of 16% or greater when compared to unprocessed soybeans.

9. The soybean product produced by the method of claim 1, wherein said soybean product has an ash content of at least 34% less when compared to unprocessed soybeans.

10. The soybean product produced by the method of claim 4, wherein said soybean product has an ash content of at least 34% less when compared to unprocessed soybeans.

11. The method of claim 1, wherein the steps consisting of a, b, c, d, and e can further comprise agitation, stirring, or mixing.

12. The method of claim 4, wherein the steps consisting of a, b, c, d, and e can further comprise agitation, stirring, or mixing.

13. The soybean product produced by the method of claim 1, wherein said soybean product has a total amino acid content of 19% or greater when compared to unprocessed soybeans on a dry weight basis.

14. The soybean product produced by the method of claim 4, wherein said soybean product has a total amino acid content of 19% or greater when compared to unprocessed soybeans on a dry weight basis.

15. The soybean product produced by the method of claim 1, wherein said soybean product has a 23% or greater total amino acid content when compared to unprocessed soybeans on a moist weight basis.

16. The soybean product produced by the method of claim 4, wherein said soybean product has a 23% or greater total amino acid content when compared to unprocessed soybeans on a moist weight basis.

17. The soybean product produced by the method of claim 1, wherein said soybean product has at least a 54% reduction in the Potassium content when compared to unprocessed soybeans.

18. The soybean product produced by the method of claim 4, wherein said soybean product has at least a 54% reduction in the Potassium content when compared to unprocessed soybeans.
